(19) United States
(12) Patent Application Publication
(10) Pub. No.: US 2005/0086698 A1
(43) Pub. Date: Apr. 21, 2005

(54) Automatic monitoring and alerting device

(76) Inventor: Wang Cheng-Yu, Hsinchu (TW)

Correspondence Address: Pavel Pogodin, Esq., 617 North Delaware Street, San Mateo, CA, 94401, US

(21) Appl. No.: 10/690,254

(22) Filed: Oct. 20, 2003

(51) Int. Cl. H04N 7/18

(52) U.S. Cl. 725/105; 348/143

(57) ABSTRACT

An automatic monitoring and alerting device comprises: a monitor module to record the image of a location in a digital format; a video integration module to convert the image data as recorded by the monitor module into a particular video format; which format comprising a format for video data file suited for mobile transmission; a mobile communications module to transmit video data generated by said video integration module and other data to a remote mobile device; and an alert module to actuate said mobile communications module and/or said monitor module when particular conditions are satisfied and to generate an alert signal to be transmitted by said mobile communications module. Images recorded by the monitor module are transmitted to the remote mobile device through a mobile communications system or the internet.

### FIELD OF THE INVENTION

The present invention relates to an automatic monitoring and alerting device, especially to a device to monitor a location with a video monitoring device and to transmit monitoring information automatically.

### BACKGROUND OF THE INVENTION

As the video imaging system is well developed during the past few years, using a video imaging system controlled by a computer system to monitor a location has become a popular application. In most applications the monitoring device records the biological or non-biological activities at a location and a computer network equipment may transmit the recorded information to a remote location or preserve the recorded information.

It has been known that to monitor a location day and night continuously is not necessary in most cases. Using a sensor to control the operation of the monitoring device and turning on the monitoring device only upon a certain situation is sensed, are well-known and widely adopted in the security guard system for factory, office and family, especially in the night time.

Most monitoring systems simply record the scene of the location, even if emergency, such as burglary, fire or other accidents, takes place. In some cases, the recorded information was damaged or destroyed by the incident to be recorded itself The objectives of the “monitoring device” thus can not be achieved.

In some applications of the monitoring device, the recorded information is transmitted and stored, preserved in a remote computer system. In some applications, the recorded information is displayed in the displaying device of the computer system, such that responsible persons, such as security guard, may observe and make proper decisions. However, since images of the scene are displayed on the displaying device of the remote computer system or on a remote displaying device, only those who are adjacent to the particular displaying device can observe the displaying device and make decisions. If the responsible person is not at site of the displaying device, the location is not under proper monitor and emergencies happening at the location can not be taken care of immediately.

Some monitoring devices are provided with an alerting module. Once an activity at the monitored location is sensed, the monitor device is actuated and, at the same time, an alert signal is generated. The alert signal will then actuate a communications equipment, such as telephone set, and the latter will transmit an alarm to particular communications equipment to attract attention. At this time, if holder of the receiving communications equipment is at the site of the remote displaying device, he/she will be given a chance to observe the location from the displaying device and make proper decisions. Otherwise, he/she can rush to the scene or to the site of the displaying device, whichever is closer, to conduct necessary observations. However, the drawbacks of such a device is that the alerting module can not make proper decision in generating the alert signals. Most alerts were proved to be false. In addition, if the monitored location or the displaying device is not nearby, holder of the remote communications equipment can not make any decision.

It is thus necessary to provide a novel monitoring and alerting device that monitors a location and provides correct alert information automatically when an incident is found.

It is also necessary to provide a novel monitoring and alerting device that conducts conditional monitoring to a location and provides monitoring information when an incident is found.

It is also necessary to provide a novel monitoring and alerting device that conducts conditional monitoring to a location and provides monitoring information to a mobile device when an incident is found.

It is also necessary to provide a novel monitoring and alerting device that conducts conditional monitoring to a location and provides monitoring information to a mobile device when an incident is found.

It is also necessary to provide a novel monitoring and alerting device that conducts conditional monitoring to a location and provides monitoring information to a remote mobile device through the internet when an incident is found.

### OBJECTIVES OF THE INVENTION

The objective of the invention is to provide a novel monitoring and alerting device that monitors a location and provides correct alert information automatically when an incident is found.

Another objective of this invention is to provide a novel monitoring and alerting device that conducts conditional monitoring to a location and provides monitoring information to a mobile device when an incident is found.

Another objective of this invention is to provide a novel monitoring and alerting device that conducts conditional monitoring to a location and provides monitoring information when an incident is found.

Another objective of this invention is to provide a novel monitoring and alerting device that conducts conditional monitoring to a location and provides monitoring information to a mobile device when an incident is found.

Another objective of this invention is to provide a novel monitoring and alerting device that conducts conditional monitoring to a location and provides monitoring information to a remote mobile device through the internet when an incident is found.

### SUMMARY OF THE INVENTION

According to the present invention, the automatic monitoring and alerting device comprises: a monitor module to record the image of a location in a digital format; a video integration module to convert the image data as recorded by the monitor module into a particular video format; which format comprising a format for video data file suited for mobile transmission; a mobile communications module to transmit video data generated by said video integration module and other data to a remote mobile device; and an alert module to actuate said mobile communications module and/or said monitor module when particular conditions are satisfied and to generate an alert signal to be transmitted by said mobile communications module.

The above and other objectives and advantages of this invention may be clearly understood from the detailed description by referring to the following drawings.

### BRIEF DESCRIPTION OF THE DRAWINGS

FIG. 1 illustrates the system diagram of the automatic monitoring and alerting device of the present invention.

FIG. 2 shows the application flowchart of one application of the automatic monitoring and alerting device of this invention.

### DETAILED DESCRIPTION OF THE INVENTION

The followings is a description of the embodiment of the automatic monitoring and alerting device of this invention.

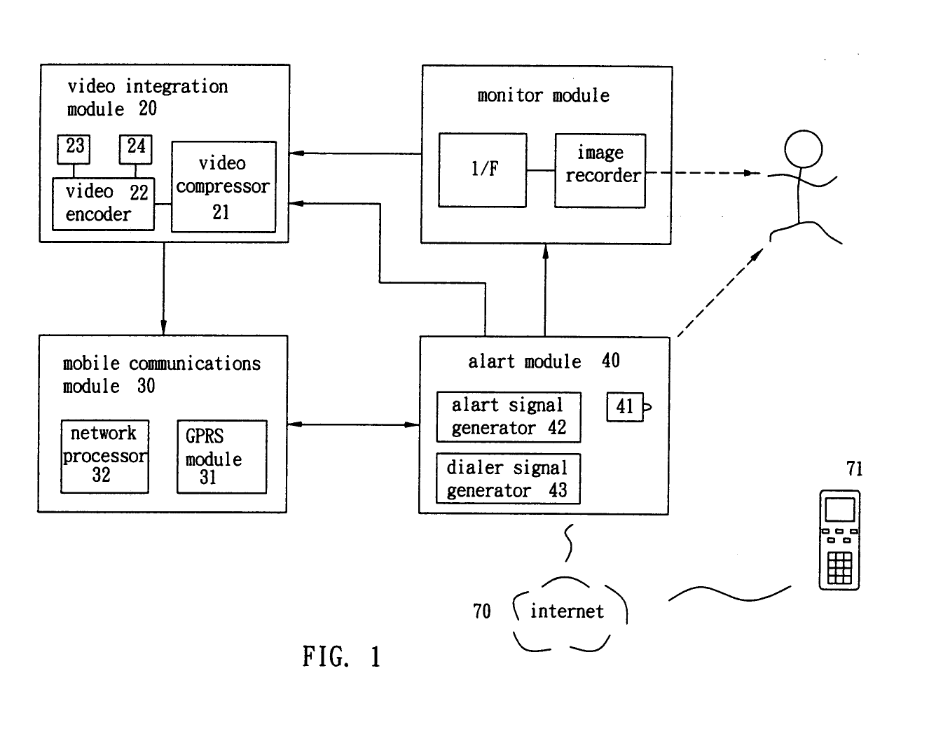

FIG. 1 illustrates the system diagram of the automatic monitoring and alerting device of the present invention. As shown in this figure, the automatic monitoring and alerting device of this invention comprises: a monitor module (10) to record the image of a location in a digital format; a video integration module (20) to convert the image data as recorded by the monitor module into a particular video format; which format comprising a format for video data file suited for mobile transmission; a mobile communications module (30) to transmit video data generated by said video integration module and other data to a remote mobile device; and an alert module (40) to actuate said mobile communications module and/or said monitor module when particular conditions are satisfied and to generate an alert signal to be transmitted by said mobile communications module.

Monitor module 10 applicable in this invention may include an image recorder 11, which may be a digital camera or a video recorder, and necessary interface 12 to connect the monitor module 10 to other modules. The image recorder 11 has a video signal processor (not shown) which converts the image as recorded into a digital format and the recorded images are output from the interface 12. Image recorders and interfaces suited in this invention are known to those skilled in the art. Detailed description thereof is thus omitted.

The video integration module 20 of the invention comprises an image compressor 21, a video encoder 22 and necessary memories 23, 24. The video compressor 21 compresses the image data so to reduce quantity of the data, so to facilitate the following processing. Suited image compressor include JPEG encoder and other applicable image compressors. In some applications, the image compressor 21 may be omitted. The video encoder 22 encodes the image data into a particular video format, such that the image data are suited for mobile transmission. Generally speaking, formats suited in this invention include QCIF, CIF etc. Of course, other formats that are applicable in this invention may be used. Encoder that may be used to conduct such video data conversion may be any of those available in the market. It is also possible to use a software technology to encode the image data into the desired video format, so to be transmitted through a mobile communications system.

In the video integration module 20, a memory 23 and a buffer memory 24 are provided to store the recorded image or video data and data in process.

The mobile communications module 30 includes a GPRS (general packet radio system) module 31 to transmit audio, video and other data to a connectable mobile communications system, so that the data will be transmitted to a designated mobile device or another computer equipment and the image represented by the video data is displayed on the displaying device of the mobile device or computer. The technology to transmit audio, video and other data with a GPRS module may be that being used in the cellular phone system. Other applicable technologies may also be used in this invention. As to displaying video information such as digital image or motion picture on the displaying device of a mobile device, such as the screen of a handset, such an application has been widely used in the cellular phone system. Of course, other technologies may also be used in this invention, as long as video information may be displayed on the displaying device of the mobile device smoothly.

In some embodiments of this invention, the GPRS module 31 connects to the mobile communications system via a network processor 32. In other words, image data grasped by the monitor module 10 are processed by the video integration module 20 so that the image data are in an MMS format to be transmitted through the mobile communications system. The network processor 32 then processes the image data with TPC/IP technology and the processed image data are transmitted to the mobile communications system by the GPRS module 31.

In some embodiments of this invention, the video data are transmitted to a designated internet service provider (not shown) via the internet (not shown), after they are processed by the network processor 32. The internet service provider then transmits the image data to the designated mobile device or remote computer equipment via the GPRS module of its own system or through the GPRS module of another telecommunication system operator. The images represented by the image data are thus displayed on the displaying device of the designated mobile device or computer equipment.

The alert module 40 comprises a sensor 41, an alert signal generator 42 and a dialer signal generator 43. Among them, the sensor may be an optoelectronic switch in most applications. An optoelectronic switch generates a signal when a moving article passes by the sensor 41. The sensor may also be a temperature sensor to sense a heat generating article that passes by or exists adjacent to the sensor 41. The sensor may also be a vibration sensor to sense the moving article adjacent to the sensor. These and other sensors are used to sense changes in the environment and to generate sensing signals when an incident is sensed. The alert signal generator 42 receives the sensing signals of the sensor 41 and generates a control signal to actuate the dialer signal generator 43, so that the dialer signal generator 43 generates dialer signals. Control signals generated by the alert signal generator 42 are also used to actuate the monitor module 10 and the video signal integration module 20 and start their operations. However, if the monitor module 10 and the video signal integration module 20 operate from time to time, actuating them with the control signals of the alert signal generator 42 is not necessary.

Dialer signals generated by the dialer signal generator 43 may comprise telephone number signals representing the telephone number of the mobile device designated 71 to receive the video image information. They can be a group of IP address and telephone number data, to connect the network processor 31 to a particular website in the internet 70, such transmission of the image data may be proceeded. In that case, the dialer signals may include in addition a set of telephone number, such that the computer equipment of the designated website may dial out and transmit the image data to a mobile device and the transmitted image may be displayed at the displaying device of the mobile device 71. In addition, the dialer signals may include a domain name or an IP address, or even an email address, so that the video data are transmitted to a computer equipment, allowing another computer equipment to access and display the transmitted image.

Transmission of image data from internet to telecommunication equipment, from telecommunication equipment to internet, rules for dispatching of data flow and for routing of information package, all these may follow the existing communication protocols as used in the internet society. Nevertheless, access of data existing at particular addresses in the network system by telecommunication equipments or computer equipments may be processed according to the generally accepted rules in the internet society. Detailed description thereof is thus omitted.

In another embodiment of this invention, under particular condition the alert signal generator 43 generates a predetermined alarm information to be transmitted along with the image data.

The automatic monitoring and alerting device as described above transmits images as recorded by the monitor module 10 to a remote computer equipment or a mobile device according to the telephone number and/or IP address data signals generated by the dialer signal generator 43 and the images are displayed in the displaying device of the remote computer equipment or the mobile device.

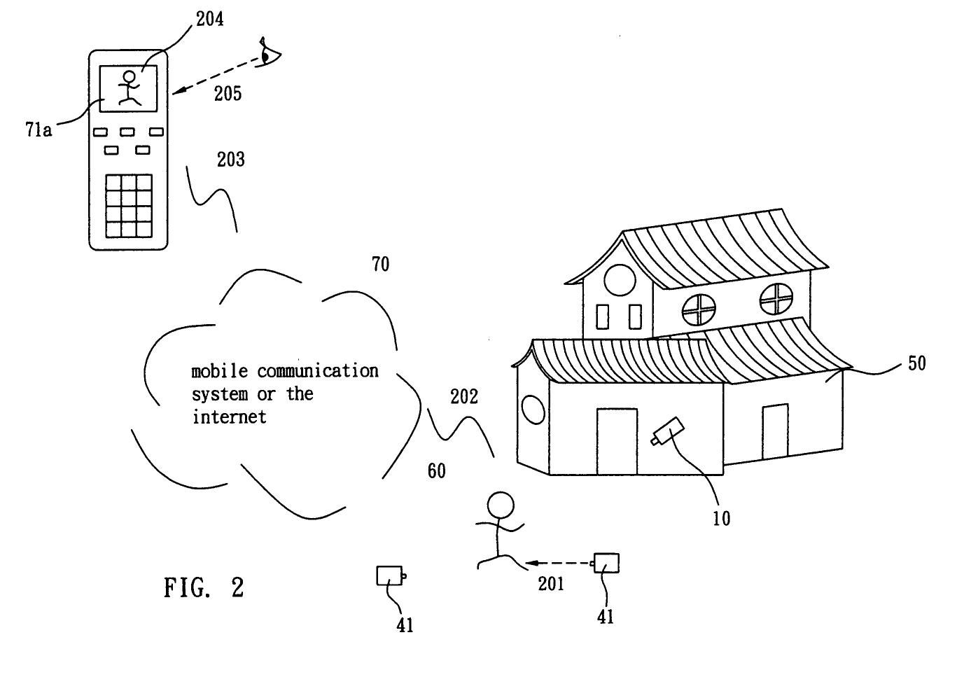

Examples of the application of the present invention are illustrated as follows. FIG. 2 shows the application flowchart of one application of the automatic monitoring and alerting device of this invention. As shown in this figure, the monitor module 10 is installed in the monitored location 50, such as at home, in factory, office building or vehicle. At 201 an accident, such as a fire, happens in the monitored location, the environmental temperature raises suddenly. Such sudden change in temperature is sensed by sensor 41. Alternatively, when an unknown person 60 enters into the monitored location 50, such an activity is sensed by sensor 41. At 202, the alert module 40 actuates the monitor module 10 and the video integration module 20 and dials a telephone number at the same time. At 203 remote mobile handset 71 is actuated by its mobile communications system operator 70 and at 204 images as recorded by the monitor module 10 are displayed at the screen 71 of the mobile handset 71. At 205 holder of the mobile handset observes the displayed images and determines to take proper actions.

In another application, the alert module 40 connects the internet 70 and transmits the video data to the remote computer equipment or mobile device 71 through the internet 70 and the images are displayed on the displaying device 71 a of the computer equipment or the mobile device 71.

With the automatic monitoring and alerting device of this invention, holder of the remote computer equipment or the mobile device may observe the situation of the monitored location by viewing the received alarm signals and the video data and make proper decisions, whenever an alert is generated. The user is able to monitor the situation of the monitored location at any time, while false alarms are effectively avoided.

It is also possible for holder of the remote computer equipment or the mobile device to actively actuate the automatic monitoring and alerting device.

As the present invention has been shown and described with reference to preferred embodiments thereof, those skilled in the art will recognize that the above and other changes may be made therein without departing from the spirit and scope of the invention.

1. An automatic monitoring and alerting device, comprising:
a monitor module to record the image of a location in a digital format;
a video integration module to convert the image data as recorded by the monitor module into a particular video format; which format comprises a format for video data file suited for mobile transmission;

2. The automatic monitoring and alerting device according to claim 1, wherein said monitor module comprises a digital camera.

3. The automatic monitoring and alerting device according to claim 1, wherein said monitor module comprises a video recorder.

4. The automatic monitoring and alerting device according to claim 1,wherein said video integration module comprises an image compressor the compress image data recorded by said monitor module, a video encoder to encode the compressed image data into a video format and memories to store image data processed and image data being processed.

5. The automatic monitoring and alerting device according to claim 4, wherein said image data are encoded in the OCIF or CIF format.

6. The automatic monitoring and alerting device according to claim 1, wherein said mobile communications module comprises a GPRS (general packet radio system) module to transmit said image data to a connectable mobile communications system, such that said data are transmitted to a designated mobile device.

7. The automatic monitoring and alerting device according to claim 1, wherein said mobile communications module further comprises a network processor to modify said image data such that said image data are suited for transmission in the internet.

8. The automatic monitoring and alerting device according to claim 1, wherein said alert module comprises a sensor to sense the environment of the location, an alert signal generator to generate alert signals when a predetermined change in the environment is sensed and a dialer signal generator to generate dialer signals when an alert signal is generated.

9. The automatic monitoring and alerting device according to claim 8, wherein said sensor is an optoelectronic sensor.

10. The automatic monitoring and alerting device according to claim 8, wherein said dialer signals comprise at least one selected from the group of telephone number, IP address, domain name and email address.

11. The automatic monitoring and alerting device according to claim 8, wherein said alert signal generator further generates a predetermined alarm information to be transmitted along with said image data.
